(19) United States
(12) Patent Application Publication
(10) Pub. No.: US 2009/0286570 A1
(43) Pub. Date: Nov. 19, 2009

(54) PORTABLE COMMUNICATION DEVICE AND METHOD OF PROCESSING EMBEDDED VISUAL CUES

(75) Inventor: Justin Pierce, JR., Cary, NC (US)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(73) Assignee: SONY ERICSSON MOBILE COMMUNICATIONS AB, Lund (SE)

(21) Appl. No.: 12/121,374

(22) Filed: May 15, 2008

(51) Int. Cl. H04M 1/00; G06K 9/00

(52) U.S. Cl. 455/556.1; 382/100

(57) ABSTRACT

A portable communication device is equipped with a camera and visual cue detection circuitry. The visual cue detection circuitry is configured to detect visual cues embedded into images and/or products. Upon detection of an embedded visual cue, the portable communication device is configured to initiate a secondary action, such as launching a game for playing or a media file for viewing, or reporting non-genuine or counterfeit products.

### TECHNICAL FIELD OF THE INVENTION

The present invention relates generally to portable communication devices, and more particularly, to a portable communication device and method of processing visual cues in captured images.

### DESCRIPTION OF RELATED ART

In recent years, portable communication devices, such as mobile phones, personal digital assistants, mobile terminals, etc., continue to grow in popularity. As the popularity of portable communication devices continues to grow, the applications for and features of portable communication devices continue to expand. Portable communication devices are appealing to users because of their capability to serve as powerful communication, data service, entertainment and information-gathering tools.

The wireless industry has experienced a rapid expansion of mobile data services and enhanced functionality. In addition, the features associated with certain types of portable communication devices have become increasingly diverse. To name a few examples, many portable communication devices have text messaging capability, web browsing functionality, electronic mail capability, video playback capability, audio playback capability, image display capability and hands-free headset interfaces.

Most mobile phones include a camera function capable of capturing still images and video images. Some of these cameras are capable of taking relatively high quality pictures. For example, some current camera phones have five to six megapixel camera systems.

### SUMMARY

To improve or otherwise augment a user's mobile phone experience, a mobile phone is equipped to capture images and detect visual cues within the captured images. The visual cues may include embedded code or images on various products, packaging or promotional items. Upon detection of an embedded visual cue, the portable communication device is configured to initiate a secondary action that provides the user with an augmented reality experience, such as the launching of a game or the viewing of a short animation or other media clip. The provision of augmented reality based on detection of embedded visual cues allows a user to interact with a product, product packaging and/or promotional materials, build brand affinity and/or detect non-genuine products.

One aspect of the disclosed technology relates to a portable communication device that includes a camera operable to capture images; visual cue detection circuitry configured to detect visual cues in a captured image; and a program stored in a memory on the portable communication device, wherein when the program is executed the program causes the portable communication device to initiate a secondary action upon detection of a visual cue in the captured image.

According to one embodiment, the visual cue includes text or code embedded into an object.

According to another embodiment, the visual cue includes an image embedded into an object.

According to another embodiment, the visual cue includes one or more fiducials disposed on an object.

According to another embodiment, the secondary action includes launching a media file for playing on the portable communication device.

According to another embodiment, the secondary action includes launching a game for playing on the portable communication device.

According to another embodiment, the secondary action includes visiting a website using the portable communication device.

According to another embodiment, the secondary action includes prompting a user to report detection of a non-genuine or counterfeit object.

According to another embodiment, the secondary action includes automated uploading of information about a non-genuine or counterfeit object.

According to another embodiment, the secondary action includes automated uploading of information about a genuine product.

According to another embodiment, the portable communication device is a mobile phone.

Another aspect of the disclosed technology relates to a method of presenting media content to a user of a portable communication device. The method includes capturing an image of an object; detecting a visual cue in the image of the object; and initiating a secondary action upon detection of the visual cue in the image of the object.

According to one embodiment, the visual cue includes code or text embedded into an object.

According to another embodiment, the visual cue includes an image embedded into an object.

According to another embodiment, the visual cue includes one or more fiducials disposed on an object.

According to another embodiment, the secondary action includes launching a media file for playing on the portable communication device.

According to another embodiment, the secondary action includes launching a game for playing on the portable communication device.

According to another embodiment, the secondary action includes visiting a website using the portable communication device.

Another aspect of the disclosed technology relates to a method of detecting counterfeit items implemented on a portable communication device. The method includes capturing an image of an item; based on the captured image, determining whether the item includes a detectable visual cue; and upon detection of an image of an item not including the detectable visual cue, prompting a user of the portable communication device to upload information about the item to a remote database.

According to another embodiment, the method includes upon detection of an image of an item not including the detectable visual cue, displaying a counterfeit or non-genuine item warning.

Another aspect of the disclosed technology relates to a method of detecting counterfeit items that includes rendering genuine items with a detectable visual cue that is configured to be detected by a portable communication device equipped with a camera; and upon detection of an image of an item not including the detectable visual cue, prompting a user of the portable communication device to upload information about the item to a remote database or automatically uploading information about the item to a remote database.

According to another embodiment, the uploaded information includes geo-tagged and image-tagged information about the item.

These and further features of the present invention will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the spirit and terms of the claims appended thereto.

Features that are described and/or illustrated with respect to one embodiment may be used in the same way or in a similar way in one or more other embodiments and/or in combination with or instead of the features of the other embodiments.

It should be emphasized that the term “comprises/comprising” when used in this specification is taken to specify the presence of stated features, integers, steps or components but does not preclude the presence or addition of one or more other features, integers, steps, components or groups thereof.

### BRIEF DESCRIPTION OF DRAWINGS

Many aspects of the invention can be better understood with reference to the following drawings. The components in the drawings are not necessarily to scale, emphasis instead being placed upon clearly illustrating the principles of the present invention. Likewise, elements and features depicted in one drawing may be combined with elements and features depicted in additional drawings. Moreover, in the drawings, like reference numerals designate corresponding parts throughout the several views.

FIG. 1 a front view of a mobile phone as an exemplary portable communication device on which aspects of the disclosed technology may be carried out;

FIG. 2 is a back view of the mobile phone of FIG. 1;

FIG. 3 is a diagrammatic illustration of an exemplary communication system in which aspects of the disclosed technology may be carried out;

FIG. 4 is a block diagram of the exemplary portable communication device of FIG. 2;

FIG. 5 is a flow chart or functional diagram representing a method of operating a portable communication device;

FIG. 6 is a flow chart or functional diagram representing a method of presenting media content to a user of a portable communication device;

FIG. 7 is a flow chart or functional diagram representing a method of detecting counterfeit items in accordance with one exemplary embodiment; and

FIG. 8 is a flow chart or functional diagram representing a method of detecting counterfeit items in accordance with another exemplary embodiment.

### DETAILED DESCRIPTION OF EMBODIMENTS

In the detailed description that follows, like components have been given the same reference numerals regardless of whether they are shown in different embodiments of the present invention. To illustrate the present invention in a clear and concise manner, the drawings may not necessarily be to scale and certain features may be shown in somewhat schematic form.

Mobile phone companies, advertisers, game developers and other businesses look for ways to build affinity with brand users or buyers. In addition businesses look for new ways for consumers to use their products or accessories (e.g. mobile phones) to interact with products or product packaging. Further, companies within the consumer electronic and mobile phone industry look for new ways to counteract the increasing number of counterfeit phones on the market. Certain mobile phone purchasers (and brand loyalists) are often the best positioned to help a company discern information about counterfeiting of its products.

Surveys of mobile phone users, particularly younger users, indicate that many purchasers of phones buy them because of their style or fashion value. These buyers tend to view phones as a fashion item or accessory, and not just as a technical instrument. Many of these purchasers (particularly those who buy the latest gadgets or high-end phones) are not unlike those who purchase other high-end fashion items (like clothes, watches, etc.), and tend to form social links with, and attach social value to, those others who buy items of the same brand.

The present disclosure provides a portable communication device equipped with a camera that is capable of detecting embedded visual cues on products, packaging and/or promotional materials. Upon detection of an embedded visual cue, the portable communication device is configured to initiate a secondary action that provides the user with an augmented reality experience, such as the launching of a game or the viewing of a short animation or other media clip. As is described more fully below, the provision of augmented reality based on detection of embedded visual cues allows a user to interact with a product, product packaging and/or promotional materials, build brand affinity and/or detect non-genuine products.

As referred to herein, the term “portable communication device” includes portable radio communication equipment. The term “portable radio communication equipment”, which herein after is referred to as a mobile phone, a mobile device, a mobile radio terminal or a mobile terminal, includes all electronic equipment, including, but not limited to, mobile telephones, pagers, communicators, i.e., electronic organizers, smartphones, personal digital assistants (PDAs), or the like. While the present invention is being discussed with respect to portable communication devices, it is to be appreciated that the invention is not intended to be limited to portable communication devices, and can be applied to any type of handheld mobile electronic equipment equipped with camera or image capture or detection functionality.

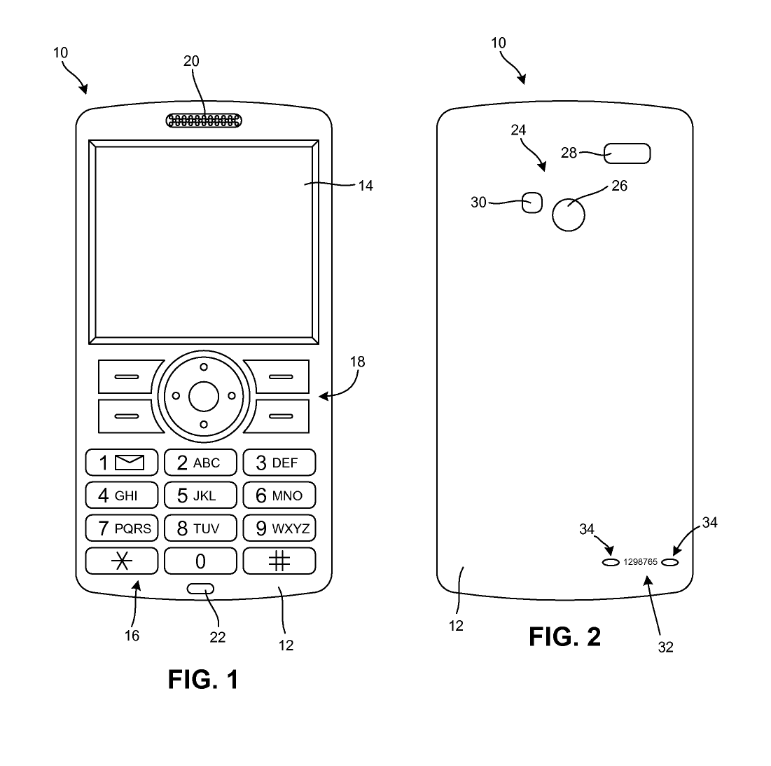

Referring initially to FIG. 1 and FIG. 2, a portable communication device 10 is shown in accordance with the present invention. In the exemplary embodiment described herein, the portable communication device is a mobile phone 10. Of course, it will be appreciated that the present invention is applicable to other portable communication devices. The mobile phone 10 is shown as having a “block” or “candy bar” type of housing 12, but it will be appreciated that other form factor or housing types, such as clamshell or slider-type housings may be utilized without departing from the scope of the present invention.

In the illustrated embodiment, the mobile phone 10 includes a display 14, e.g., a standard LCD display or a touch-sensitive display, an alphanumeric keypad 16, one or more functional keys 18, e.g., a joystick or rocker key, a speaker 20 and a microphone 22. The alphanumeric keypad 16 and the functional keys 18, facilitate controlling operation of the mobile phone 10 by allowing for entry of alphanumeric information, such as telephone numbers, phone lists, contact information, notes and the like. The functional keys 18 typically facilitate navigation through various user menus including initiating and conducting phone calls and other communications. For example, the mobile phone may include a dedicated or dynamic image capture or shutter key that is activated for capturing an image, still or video, of an object.

The display 14 displays information to a user, such as recorded digital media, e.g., recorded photos and videos, operating state, time, phone numbers, contact information and various navigational menus, which enable the user to utilize the various features of the mobile phone 10. In addition, the display may be configured to function as a viewfinder when the mobile phone's camera function is in use.

As shown in FIG. 2, the mobile phone 10 is equipped with a camera assembly 24 for taking digital still pictures and/or digital video clips. It is emphasized that the electronic device 10 need not be a mobile telephone, but could be a dedicated camera or some other portable communication device as indicated above.

The camera assembly 24 may be arranged as a typical camera assembly that includes imaging optics 26 to focus light from a scene within the field-of-view of the camera assembly 12 onto a sensor. The sensor converts the incident light into image data. The imaging optics 26 may include various optical components, such as a lens assembly and components that supplement the lens assembly (e.g., a protective window, a filter, a prism, and/or a mirror). The imaging optics 24 may be associated with focusing mechanics, focusing control electronics (e.g., a multi-zone autofocus assembly), optical zooming mechanics, etc. Other camera assembly 24 components may include a flash 28 to provide supplemental light during the capture of image data for a photograph, a light meter 30, the display 14 for functioning as an electronic viewfinder and as part of an interactive user interface, the keypad 16 and the navigational keys or functional buttons 18 for accepting user inputs, an optical viewfinder (not shown), and any other components commonly associated with cameras.

As is discussed more fully below, a product, such as mobile phone 10, may include one or more visual cues (referred to generally with reference numeral 32), such as code, text and/or images or symbols 34 embedded into or otherwise disposed on the product, product packaging or promotional materials associated with a product or brand. As is discussed more fully below, the mobile phone may include cue detection circuitry that is configured to detect visual cues in images captured by the camera assembly 24.

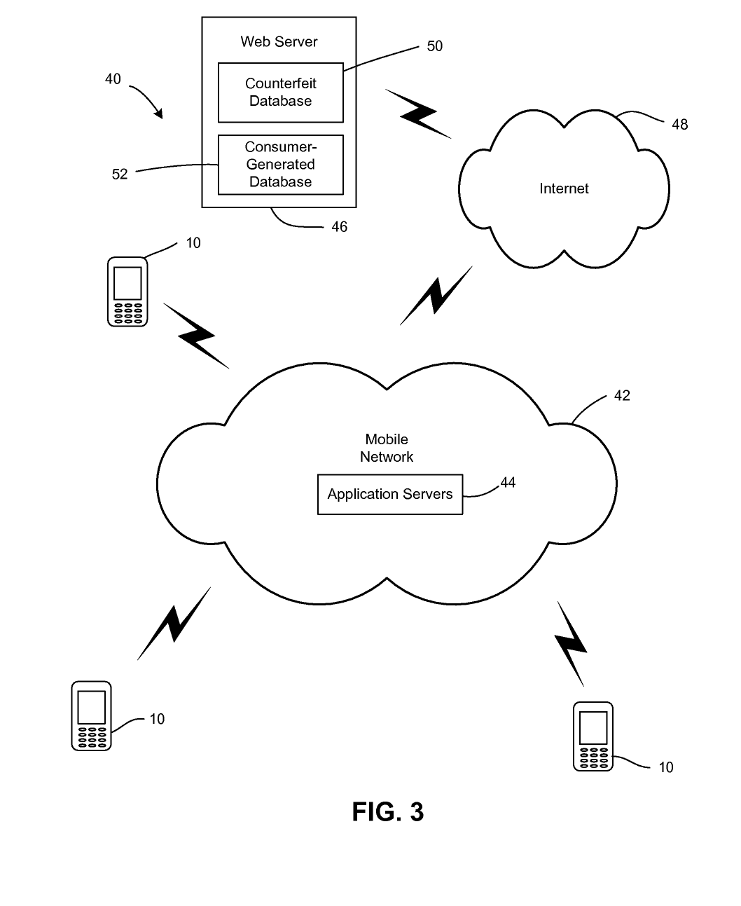

Referring now to FIG. 3, the mobile phone 10 may be configured to operate as part of a communication system 40. The communication system 40 includes a mobile network 42, such as a mobile cellular telephony network, that facilitates communication, such as voice communication and/or data transfer between a plurality of portable communication devices 10, such as mobile phones, mobile terminals or the like. The mobile network 42 includes one or more servers (referred to generally as application server 44) for managing calls placed by and destined to the portable communication device 10, as well as supporting one or more applications (e.g., an augmented reality application or a counterfeit detection application) by (e.g., including appropriate hardware and/or application programs for receiving consumer-generated information and creating consumer-generated databases personality profiles). In the illustrated embodiment, the portable communication device may transfer consumer-generated data to a remote server 46 via the Internet 48 for creation of, for example, a counterfeit-goods database 50 as well as other consumer-generated databases 52).

It will be appreciated that the mobile network 40 includes a network infrastructure, portions of which are used or otherwise accessed by the portable communication devices. The portable communication devices 10 may interact with each other and/or the network infrastructure in accordance with any suitable communication standard, including, but not limited to, Advanced Mobile Phone Service (AMPS), Digital Advanced Mobile Phone Service (D-AMPS), General Packet Radio Service (GPRS), Universal Mobile Telecommunications System (UMTS), Global System for Mobile Communications (GSM), Code Division Multiple Access (CDMA), Worldwide Interoperability for Microwave Access (WiMax), Voice-Over IP (VoIP), Session Initiated Protocol (SIP), Wireless Local Area Network (WLAN) or the like. In other words, the communication system shown in FIG. 3 is provided for purposes of explaining aspects of the present invention, without limiting the invention to a particular communication system design, architecture or communication standard. Further aspects of the invention may be employed in the connection with device-to-device exchanges (wired, wireless or via intermediary).

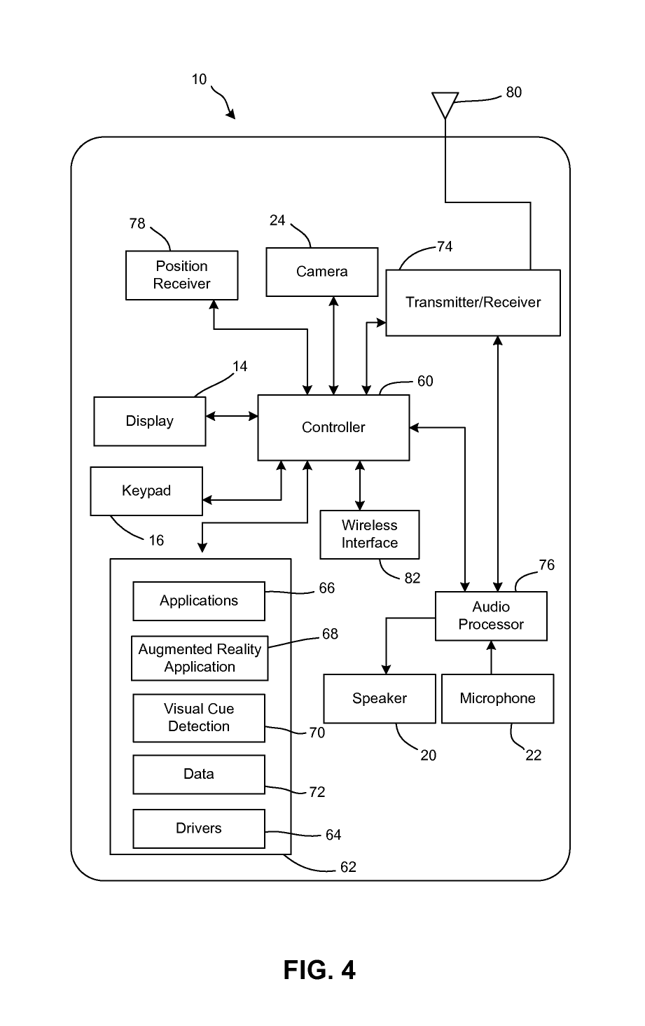

FIG. 4 represents a functional block diagram of a portable communication device 10. The portable communication device 10 includes a controller 60 that controls the overall operation of the portable communication device. The controller 60 may include any commercially available or custom microprocessor or microcontroller. Memory 62 is operatively connected to the controller 60 for storing control programs and data used by the portable communication device. The memory 62 is representative of the overall hierarchy of memory devices containing software and data used to implement the functionality of the portable communication device in accordance with one or more aspects described herein. The memory 62 may include, for example, RAM or other volatile solid-state memory, flash or other non-volatile solid-state memory, a magnetic storage medium such as a hard disk drive, a removable storage media, or other suitable storage means. In addition to handling voice communications, the portable communication device 10 may be configured to transmit, receive and process data, such as consumer-generated data transmitted to a web server, text messages (also known as short message service or SMS), electronic mail messages, multimedia messages (also known as MMS), image files, video files, audio files, ring tones, streaming audio, streaming video, data feeds (e.g., podcasts) and so forth.

In the illustrated embodiment, memory 62 stores drivers 36 (e.g., I/O device drivers), application programs 66, such as an augmented reality application program 68, a visual cue detection program (also referred to as visual cue detection circuitry) 70 and application program data 72 (e.g., consumer-generated content created by the portable communication device). The I/O device drivers include software routines that are accessed through the controller 60 (or by an operating system (not shown) stored in memory 62) by the application programs, including the augmented reality application program 68, to communicate with devices such as the display 14 and keypad 16 (e.g., a standard keypad, a QWERTY keypad or a touch screen keypad) as well as other input/output ports.

The application programs, including the augmented reality program 68 and the visual cue detection program 70, comprise programs that implement various features of the portable communication device 10, such as voice calls, e-mail, Internet access, multimedia messaging, contact manager and the like. As is described more fully below, the augmented reality application 68 and the visual cue detection application 70 (which may be separate applications or integrated into a common application) comprise a program, logic routine, code or circuitry that detect visual cues in a captured image and initiate one or more secondary actions upon detection of one or more predetermined visual cues in a captured image.

A person having ordinary skill in the art of computer programming, and specifically in applications programming for mobile phones, will consider it obvious in view of the provided description how to program a mobile phone to operate and carry out the functions described herein with respect to augmented reality application 68 and the visual cue detection application 70 (and any interfacing between the augmented reality application 68 and the visual cue detection application 70 and other application programs (e.g., messaging application programs, such as a universal messenger program, media application programs and the like). Accordingly, details as to the specific programming code have been left out. Also, while the augmented reality and visual cue detection functionality may be carried out via the controller 32 and augmented reality application and visual cue detection application (alone or in conjunction with other application programs) in memory 62 in accordance with inventive aspects, such function also could be carried out via dedicated hardware, firmware, software or combinations thereof without departing from the scope of the present invention.

With continued reference to FIG. 4, the controller 60 interfaces with the aforementioned display 14 and keypad 16 (and any other user interface device(s)), a transmitter/receiver 74 (often referred to as a transceiver), audio processing circuitry, such as an audio processor 76, and a position determination element or position receiver 78, such as a global positioning system (GPS) receiver. As is described above, the portable communication device 10 includes a camera 24 (e.g., a still camera, a video camera, an audio recorder or the like) that captures digital pictures, audio and/or video. Image, audio and/or video files corresponding to the pictures, songs and/or video may be stored in memory 62.

An antenna 80 is coupled to the transmitter/receiver 74 such that the transmitter/receiver 74 transmits and receives signals via antenna 80, as is conventional. The portable communication device includes an audio processor 76 for processing the audio signals transmitted by and received from the transmitter/receiver. Coupled to the audio processor 76 are the speaker 20 and microphone 22, which enable a user to listen and speak via the portable communication device. Audio data may be passed to the audio processor 76 for playback to the user. The audio data may include, for example, audio data from an audio file stored in the memory 62 and retrieved by the controller 60. The audio processor 48 may include any appropriate buffers, decoders, amplifiers and the like.

The portable communication device also may include one or more local wireless interfaces (indicated generally as wireless interface 82), such as an infrared transceiver and/or an RF adapter, e.g., a Bluetooth adapter, WLAN adapter, Ultra-Wideband (UWB) adapter and the like, for establishing communication with an accessory, a hands free adapter, e.g., a headset that may audibly output sound corresponding to audio data transferred from the portable communication device 10 to the adapter, another mobile radio terminal, a computer, or any other electronic device. Also, wireless interface 60 may be representative of an interface suitable for communication within a cellular network or other wireless wide-area network (WWAN).

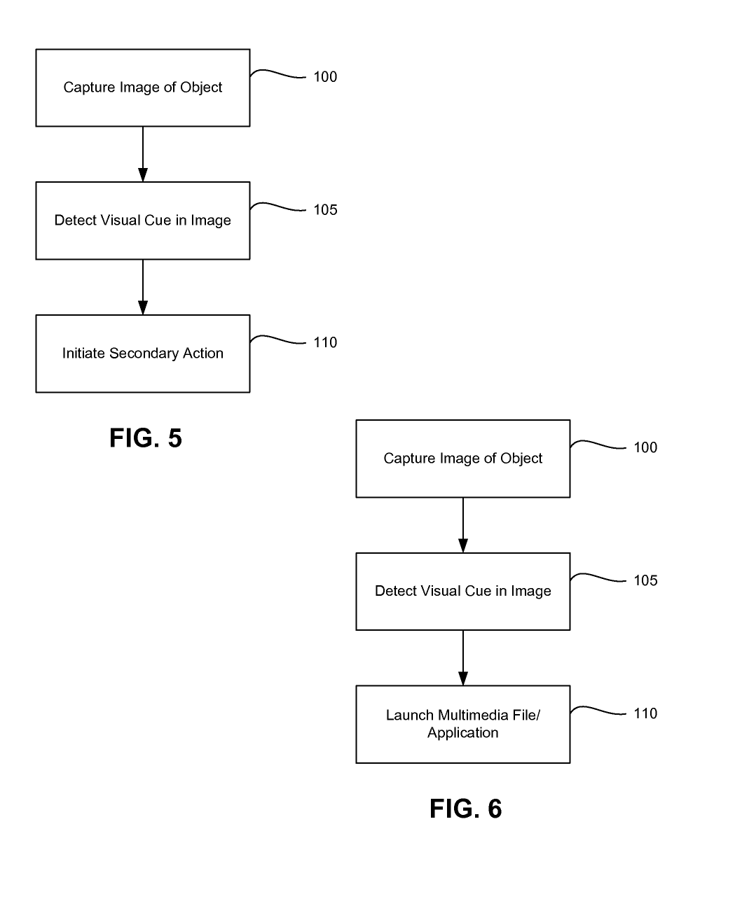

While for purposes of simplicity of explanation, the flow charts or functional diagrams in FIGS. 5-8 include a series of steps or functional blocks that represent one or more aspects of the relative operation of the portable communication device 10 (or the portable communication device 10 in data communication with a web server), it is to be understood and appreciated that aspects of the described invention are not limited to the order of steps or functional blocks, as some steps or functional blocks may, in accordance with aspects of the present invention occur in different orders and/or concurrently with other steps or functional blocks from that shown or described herein. Moreover, not all illustrated steps or functional blocks of aspects of relevant operation may be required to implement a methodology in accordance with an aspect of the invention. Furthermore, additional steps or functional blocks representative of aspects of relevant operation may be added without departing from the scope of the present invention.

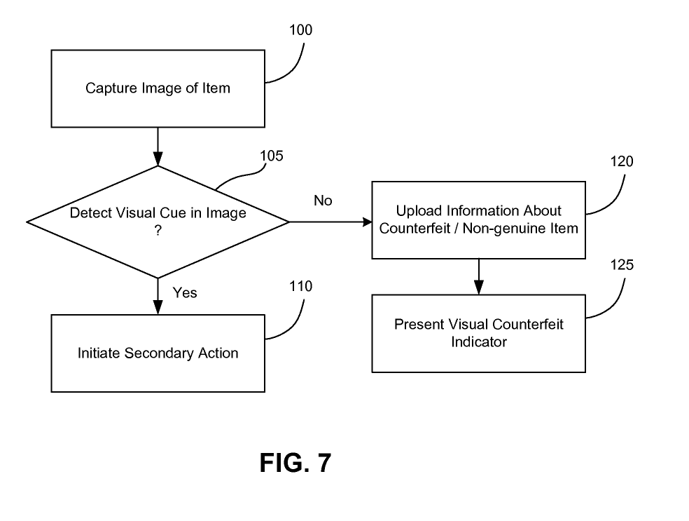

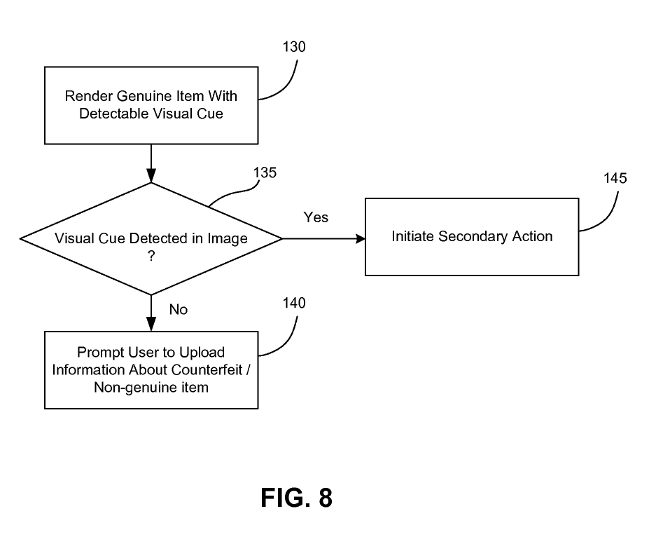

The methodologies illustrated in FIG. 5 and FIG. 6, which may be implemented on or through a portable communication device, relate to methods of providing a user with an augmented reality experience and/or methods of presenting media content to a user of a portable communication device. Further, the methodologies illustrated in FIG. 7 and FIG. 8, which also may be implemented on or through a portable communication device, relate to methods of detecting counterfeit items.

Turning now to FIG. 5 and FIG. 6, methods of operating a portable communication device or otherwise providing a mobile phone user with an augmented reality experience or presenting media content to a user begins at functional block 100, where the mobile phone captures an image of an object. In one exemplary embodiment, capturing an image of an object involves using the mobile phone's camera function to snap a photo of an object, for example, a mobile phone ad, a mobile phone poster, a product or product packaging. It will be appreciated that while aspects of the invention are being described with respect to mobile phone products, mobile phone packaging and/or mobile phone ads or posters, the invention also is applicable to the capture of images relating to any kind of ad, poster, media display item, product, and/or product packaging. For example, aspects of the invention may be employed in connection with other products, such as batteries, clothing, tools, etc.

Once an image of a product, product packaging and/or advertising material has been captured, at functional block 105, the mobile phone may operate to determine or otherwise detect whether a visual cue is embedded or otherwise disposed within the captured image. It will be appreciated that a variety of visual cues may be embedded or otherwise disposed within an image without departing from the scope of the present invention (see, for example, FIG. 2). For example, a suitable visual cue may include code or text embedded into an object, object packaging or object advertising materials. In addition, the visual cue may include one or more predetermined images embedded into an object and/or one or more fiducial markers disposed on an object.

Detection of a visual cue in the captured image may be achieved using suitable visual cue detection circuitry or a visual cue detection application program. For example, visual detection circuitry may be configured to scan an image looking for one or more predetermined visual cues (text, code, images or the like) within the image captured by the mobile phone.

At functional block 110, upon detection of a predetermined visual cue within the image, the portable communication device is configured to initiate a secondary action. It will be appreciated that a variety of actions may be initiated without departing from the scope of the present invention. For example, the secondary action may include launching a media application that augments the user's reality experience. For example, the secondary action may allow the user to play a game (e.g., play a game using the captured image as a backdrop), view a short video clip, view a series of images, view a short animation or the like, thereby augmenting or otherwise integrating the actual object, image, or item being viewed.

For example, an object, object packaging or advertising materials may include a visual cue or cues that, when detected, triggers the launching of a promotional video clip, movie trailer or video game to help promote a future movie, television show or product launch. It will be appreciated that other types of augmented reality experiences may be provided allowing users to interact and build affinity for a particular brand or a particular product. Further it will be appreciated that initiating a secondary action may simply include the prompting of a “pop-up” for a related product or movie experience that may be selected by a user for contemporaneous viewing or downloading at a later time.

Turning now to FIG. 7, a method of detecting a counterfeit or non-genuine item is provided. The method begins at functional block 100 where the mobile phone captures an image of an item is captured. As is described above, capture of an image can simply include the user taking a photo of a given product, for example a mobile phone, a fashion item or accessory or another piece of electronic equipment.

After capturing an image of an item, the portable communication device may operate to detect whether one or more visual cues can be found in the captured image. As is described above, detection of visual cues in an image may be carried out using suitable visual cue detection circuitry or application program in which an image is scanned to determine whether one or more predetermined visual cues (e.g., embedded text, embedded code, embedded images or the like) can be found in the captured image. In this instance, if no predetermined visual cue is found in the captured image, it may be determined that the product being imaged is counterfeit or otherwise non-genuine because it does not include one or more predetermined or predefined visual cues.

In this case, if no predetermined visual cue is detected, at functional block 120, the portable communication device may operate to upload information (e.g., to automatically upload information) about the counterfeit or non-genuine item and the circumstances upon which the counterfeit or non-genuine item was encountered. For example, if a user views what appears to be another Sony Ericsson brand phone, but it turns out that the phone does not include a detectable visual cue indicative of a Sony Ericsson brand mobile phone, and, therefore, the mobile phone is actually a counterfeit, the mobile phone may automatically upload geo-tagged an image-based information about the sighting to a remote system or database that stores aggregate data on reported counterfeit or non-genuine items. This information could later be used by a company's legal and anti-counterfeiting departments to better understand how many products are being counterfeited, where they are being used and other relevant data. While the exemplary embodiment is being described in connection with viewing an image of another mobile phone, it is to be appreciated that the relevant operation may be applied to a variety of items and products, packaging, batteries, clothing, tools, and other accessories.

At functional block 125, upon detection of a potential counterfeit or non-genuine item, the mobile phone may present a visual indication to the user regarding the detection of what appears to be a counterfeit or non-genuine item. For example, the user may see a warning image on the display (e.g., the “Jolly Rogers” pirate flag or a skull and cross bones image or other warning image) letting the user know that the product/phone that they are viewing may not be genuine. Of course, if the visual cue detection circuitry detects the presence of one or more visual cues in the captured image, a secondary action may be initiated at functional block 110, as is described more fully above.

While the above method is described in terms of automatic or automated upload of information upon detection of a non-genuine or counterfeit product or item, it will be appreciated that the mobile phone may be configured to engage in upload (e.g., automated upload or user-prompted upload) of information upon detection of a genuine item, for example, an item or product on which or in connection with which one or more predetermined visual cues are detected.

Turning now to FIG. 8, another aspect of a method of detecting counterfeit or non-genuine items is provided. The method begins at functional block 130 where genuine items are rendered with a detectable visual cue. As is described above, items such as products, packaging, batteries, clothing, tools and the like may be rendered with one or more detectable visual cues (see, for example, FIG. 2). As is described above, visual cues may include code, text, and/or images or fiducials embedded or otherwise disposed within a product or product packaging. At functional block 135, a mobile phone may operate to detect the presence of one or more predetermined visual cues in a captured image.

At functional block 140, if it is determined that no predetermined visual cues can be found in the captured image, the portable communication device may prompt a user to upload information about the counterfeit or non-genuine item in a manner described above with respect to FIG. 7. Of course, if one or more predetermined visual cues are detected in the captured image of an object, the portable communication device may operate to initiate a secondary action as is described above.

The use of visual cue detection and augmented reality based on detection of embedded visual cues provides for an enhanced user experience, while also providing additional ways to build affinity with brand users or buyers. The augmented reality functionality provides new ways for users to use their mobile phones to interact with products, product packaging and/or promotional materials. Further, the provision of visual cue detection may provide an effective method for detecting the presence of counterfeit or non-genuine items.

Further, the provision of the automatic upload and aggregation of consumer-generated data may provide for a number of useful applications in addition to the detection and possible prevention of counterfeiting. For example, the automatic uploading of consumer-generated data into a consumer-generated database may allow companies and other providers to gather additional useful information about the users of their products.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

1. A portable communication device comprising:
a camera operable to capture images;
visual cue detection circuitry configured to detect visual cues in a captured image; and
a program stored in a memory on the portable communication device, wherein when the program is executed the program causes the portable communication device to initiate a secondary action upon detection of a visual cue in the captured image.

2. The portable communication device of claim 1, wherein the visual cue includes text or code embedded into an object.

3. The portable communication device of claim 1, wherein the visual cue includes an image embedded into an object.

4. The portable communication device of claim 1, wherein the visual cue includes one or more fiducials disposed on an object.

5. The portable communication device of claim 1, wherein the secondary action includes launching a media file for playing on the portable communication device.

6. The portable communication device of claim 1, wherein the secondary action includes launching a game for playing on the portable communication device.

7. The portable communication device of claim 1, wherein the secondary action includes visiting a website using the portable communication device.

8. The portable communication device of claim 1, wherein the secondary action includes prompting a user to report detection of a non-genuine or counterfeit object.

9. The portable communication device of claim 1, wherein the secondary action includes automated uploading of information about a non-genuine or counterfeit object.

10. The portable communication device of claim 1, wherein the secondary action includes automated uploading of information about a genuine product.

11. The portable communication device of claim 1, wherein the portable communication device is a mobile phone.

12. A method of presenting media content to a user of a portable communication device, the method comprising:
capturing an image of an object;
detecting a visual cue in the image of the object; and
initiating a secondary action upon detection of the visual cue in the image of the object.

13. The method of claim 12, wherein the visual cue includes code or text embedded into an object.

14. The method of claim 12, wherein the visual cue includes an image embedded into an object.

15. The method of claim 12, wherein the visual cue includes one or more fiducials disposed on an object.

16. The method of claim 12, wherein the secondary action includes launching a media file for playing on the portable communication device.

17. The method of claim 12, wherein the secondary action includes launching a game for playing on the portable communication device.

18. The method of claim 12, wherein the secondary action includes visiting a website using the portable communication device.

19. A method of detecting counterfeit items implemented on a portable communication device, the method comprising:
capturing an image of an item;
based on the captured image, determining whether the item includes a detectable visual cue; and
upon detection of an image of an item not including the detectable visual cue, prompting a user of the portable communication device to upload information about the item to a remote database.

20. The method of claim 19, further comprising:
upon detection of an image of an item not including the detectable visual cue, displaying a counterfeit or non-genuine item warning.

21. A method of detecting counterfeit items, the method comprising:
rendering genuine items with a detectable visual cue that is configured to be detected by a portable communication device equipped with a camera; and
upon detection of an image of an item not including the detectable visual cue, prompting a user of the portable communication device to upload information about the item to a remote database or automatically uploading information about the item to a remote database.

22. The method of claim 21, wherein the uploaded information includes geo-tagged and image-tagged information about the item.
